(19) United States
(12) Patent Application Publication
(10) Pub. No.: US 2025/0091518 A1
(43) Pub. Date: Mar. 20, 2025

(54) CARGO NET HOOK

(71) Applicant: GM Global Technology Operations LLC, Detroit, MI (US)

(72) Inventor: Ernesto Artigas, Tula de Allende (MX)

(73) Assignee: GM Global Technology Operations LLC, Detroit, MI (US)

(21) Appl. No.: 18/468,997

(22) Filed: Sep. 18, 2023

(51) Int. Cl. B60R 7/04; B60R 11/00

(52) U.S. Cl. CPC B60R 7/04; B60R 2011/0061; B60R 2011/0071

(57) ABSTRACT

A cargo hook for a motor vehicle includes a hook body base having a first side, a second side disposed on an opposite side from the first side, and a cargo net hook body portion attached to the first side of the hook body base. The cargo hook further includes an anchor body portion including an anchor neck extending from a proximal first end attached to the second side of the hook body base to a distal second end and defining a central rotational axis, an anchor head disposed at the distal second end of the anchor neck, and includes one or more anchor wings extending radially outwardly to an outermost wing side surface from the anchor neck.

### INTRODUCTION

The information provided in this section is for the purpose of generally presenting the context of the disclosure. Work of the presently named inventors, to the extent it is described in this section, as well as aspects of the description that may not otherwise qualify as prior art at the time of filing, are neither expressly nor impliedly admitted as prior art against present disclosure.

The present disclosure relates generally to cargo hooks and methods for assembling a subassembly to a vehicle. Cargo hooks provide an aesthetically pleasing appearance to the passenger compartment area of a vehicle. In some instances, cargo hooks may also provide a function that vehicle users may exploit when the vehicle is being driven or, alternatively, when the vehicle is arranged in a parked state. Furthermore, original equipment manufacturers (OEMs) continue to seek to simplify and find efficiencies in the process of assembling a vehicle, which also includes the attachment of interior trim components to a frame of the vehicle.

### SUMMARY

An aspect of the disclosure provides a cargo hook for a motor vehicle. The cargo hook includes a hook body base having a first side, a second side disposed on an opposite side from the first side, and a cargo net hook body portion attached to the first side of the hook body base. The cargo hook further includes an anchor body portion including an anchor neck extending from a proximal first end attached to the second side of the hook body base to a distal second end and defining a central rotational axis. The anchor body portion further includes an anchor head disposed at the distal second end of the anchor neck, and includes one or more anchor wings extending radially outwardly to an outermost wing side surface from the anchor neck.

This aspect may include one or more of the following optional features. In some examples, each of the one or more anchor wings includes a first end surface disposed opposite the second side of the hook body base and a second end surface disposed on an opposite side from the first end surface. In some implementations, each of the one or more anchor wings may include a lead surface extending from the first end surface to the second end surface. In some configurations, each of the one or more anchor wings may include a first chamfer surface extending between the first end surface and the lead surface. Moreover, the first end surface may be oriented at an oblique angle (θ₅₂) relative to the central rotational axis of the anchor body portion. In some implementations, the first end surface converges with the second side of the hook body base along a direction from the lead surface. In some implementations, the anchor neck may define a first portion of a neck side surface extending from the first end surface to the second side of the hook body base and spaced radially inwardly from the outermost wing side surface.

In some configurations, the cargo net hook body portion includes one or more hook members. In some implementations, the one or more hook members include a diametrically opposed pair of hook members including a first hook member and a second hook member. The cargo hook may include each of the first hook member and the second hook member (22b) including an arcuate body defining a first hook opening extending in an axial direction through each of the first hook member and the second hook member, wherein the cargo net hook body portion includes a second hook opening that permits radial access to the first hook opening. In some examples, the cargo hook includes the cargo net hook body portion including a cross member extending across and connecting the first hook member to the second hook member. In these examples, the cross member may include the first hook member, the second hook member, and the hook body base cooperate to define a loop member defining a third hook opening.

Another aspect of the disclosure provides a cargo hook for a motor vehicle. The cargo hook includes a hook body base having a first side and a second side disposed on an opposite side from the first side and a cargo net hook body portion attached to the first side of the hook body base. The cargo net hook body portion includes a diametrically opposed pair of hook members and a cross member extending across and connecting the pair of the hook members. The cargo hook further includes an anchor body portion configured to selectively attach the cargo hook to a frame of the motor vehicle.

This aspect may include one or more of the following optional features. In some implementations, each hook member of the pair of the hook members includes an arcuate body defining a first hook opening extending in an axial direction through the hook member and a second hook opening that permits radial access to the first hook opening. In some configurations, the second hook opening of a first one of the pair of the hook members may face in an opposite direction from the second hook opening of a second one of the pair of the hook members. In some examples, the cross member, the pair of the hook members, and the hook body base cooperate to define a loop member defining a third hook opening. In some implementations, the cargo hook may include the first hook opening of each of the pair of the hook members and the third hook opening extend in the same direction through the cargo net hook body portion. In these configurations, the cross member may extend along an arcuate path across the pair of the hook members.

Another aspect of the disclosure provides a cargo hook for a motor vehicle. The cargo hook includes a hook body base having a first side and a second side disposed on an opposite side from the first side and a cargo net hook body portion attached to the first side of the hook body base. The cargo net hook body portion includes a diametrically opposed pair of hook members and a cross member extending across and connecting the pair of the hook members. The cargo hook further includes an anchor body portion including an anchor neck extending from a proximal first end attached to the second side of the hook body base to a distal second end and defining a central rotational axis. The anchor body portion further includes an anchor head disposed at the distal second end of the anchor neck and including one or more anchor wings extending radially outwardly to an outermost wing side surface from the anchor neck.

This aspect may include the following optional features. In some examples, each hook member of the pair of the hook members includes an arcuate body defining a first hook opening extending in an axial direction through the hook member and a second hook opening that permits radial access to the first hook opening.

The details of one or more implementations of the disclosure are set forth in the accompanying drawings and the description below. Other aspects, features, and advantages will be apparent from the description and drawings, and from the claims.

### BRIEF DESCRIPTION OF THE DRAWINGS

The drawings described herein are for illustrative purposes only of selected configurations and are not intended to limit the scope of the present disclosure.

FIG. 1A is a front perspective view of an interior trim component in accordance with the principles of the present disclosure;

FIG. 1B is a perspective view of the interior trim component of FIG. 1A, shown retaining a cargo net interface portion including an elastic cord;

FIG. 1C is a perspective view of the interior trim component of FIG. 1A, shown retaining another example of a cargo net interface portion including a plastic hook;

FIG. 2 is a side view of the interior trim component of FIG. 1A;

FIG. 3 is a rear perspective view of the cargo hook of FIG. 1A;

FIG. 4 is a bottom plan view of the cargo hook of FIG. 1A;

FIG. 5 is a front perspective view of a portion of a frame of a vehicle and the cargo hook of FIG. 1A, whereby an anchor body portion of the cargo hook is arranged proximate a frame passage of the frame of the vehicle;

FIG. 6A is another front perspective view of the portion of the frame of the vehicle according and the cargo hook of FIG. 5, whereby the anchor body portion of the cargo hook is arranged within the frame passage of the frame of the vehicle;

FIG. 6B is a rear perspective view of the portion of the frame of the vehicle and the cargo hook according to FIG. 6A;

FIG. 7A is another front perspective view of the portion of the frame of the vehicle and the cargo hook according to FIGS. 6A-6B, whereby the cargo hook is rotated relative the portion of the frame of the vehicle for securing the anchor body portion to the portion of the frame of the vehicle; and

FIG. 7B is a cross-sectional view of the portion of the frame of the vehicle and the cargo hook according to line 7B-7B of FIG. 7A.

Corresponding reference numerals indicate corresponding parts throughout the drawings.

### DETAILED DESCRIPTION

Example configurations will now be described more fully with reference to the accompanying drawings. Example configurations are provided so that this disclosure will be thorough, and will fully convey the scope of the disclosure to those of ordinary skill in the art. Specific details are set forth such as examples of specific components, devices, and methods, to provide a thorough understanding of configurations of the present disclosure. It will be apparent to those of ordinary skill in the art that specific details need not be employed, that example configurations may be embodied in many different forms, and that the specific details and the example configurations should not be construed to limit the scope of the disclosure.

The terminology used herein is for the purpose of describing particular exemplary configurations only and is not intended to be limiting. As used herein, the singular articles “a,” “an,” and “the” may be intended to include the plural forms as well, unless the context clearly indicates otherwise. The terms “comprises,” “comprising,” “including,” and “having,” are inclusive and therefore specify the presence of features, steps, operations, elements, and/or components, but do not preclude the presence or addition of one or more other features, steps, operations, elements, components, and/or groups thereof. The method steps, processes, and operations described herein are not to be construed as necessarily requiring their performance in the particular order discussed or illustrated, unless specifically identified as an order of performance. Additional or alternative steps may be employed.

When an element or layer is referred to as being “on,” “engaged to,” “connected to,” “attached to,” or “coupled to” another element or layer, it may be directly on, engaged, connected, attached, or coupled to the other element or layer, or intervening elements or layers may be present. In contrast, when an element is referred to as being “directly on,” “directly engaged to,” “directly connected to,” “directly attached to,” or “directly coupled to” another element or layer, there may be no intervening elements or layers present. Other words used to describe the relationship between elements should be interpreted in a like fashion (e.g., “between” versus “directly between,” “adjacent” versus “directly adjacent,” etc.). As used herein, the term “and/or” includes any and all combinations of one or more of the associated listed items.

The terms first, second, third, etc. may be used herein to describe various elements, components, regions, layers and/or sections. These elements, components, regions, layers and/or sections should not be limited by these terms. These terms may be only used to distinguish one element, component, region, layer or section from another region, layer or section. Terms such as “first,” “second,” and other numerical terms do not imply a sequence or order unless clearly indicated by the context. Thus, a first element, component, region, layer or section discussed below could be termed a second element, component, region, layer or section without departing from the teachings of the example configurations.

The present disclosure relates generally to cargo hooks, and more particularly, to cargo hooks configured to be arranged in a passenger compartment area of a vehicle, such as, for example, a rear cargo area of the vehicle. In some implementations, the cargo hook is a cargo net interface member that is configured to support a portion of a cargo net. A first end of the cargo net interface member includes a fixture element, which may be alternatively referred to as a cargo net hook body portion that is exposed to the passenger compartment area for removably-securing the portion of the cargo net thereto. A second end of the cargo net interface member includes an anchor body portion that is not exposed to the passenger compartment area and is configured for being secured to a portion of a body or a frame of the vehicle. The anchor body portion of the cargo net hook and corresponding portion of the frame of the vehicle are configured to simplify and promote efficiencies in the process of assembling a vehicle.

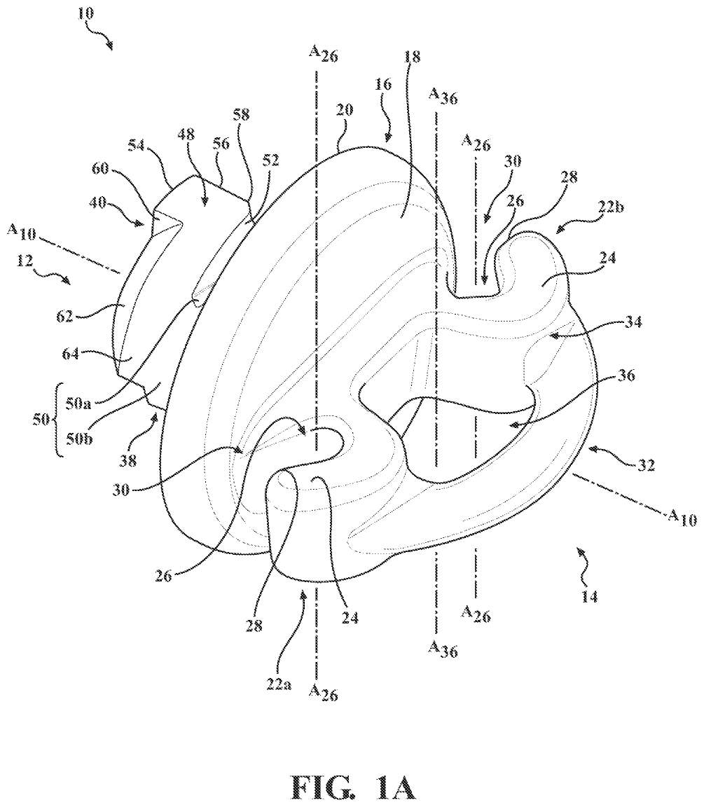

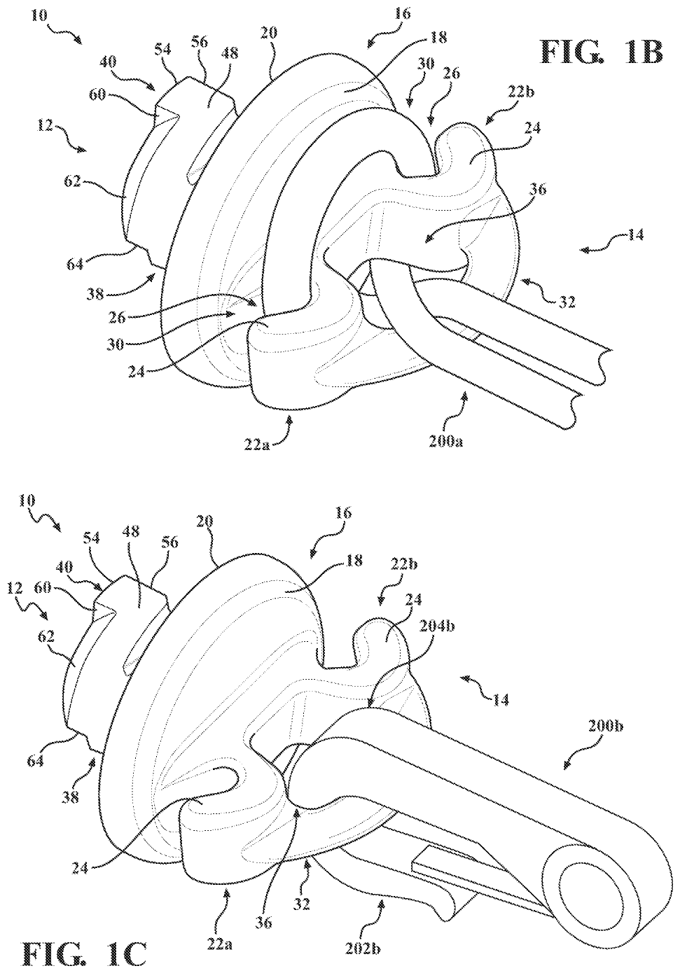

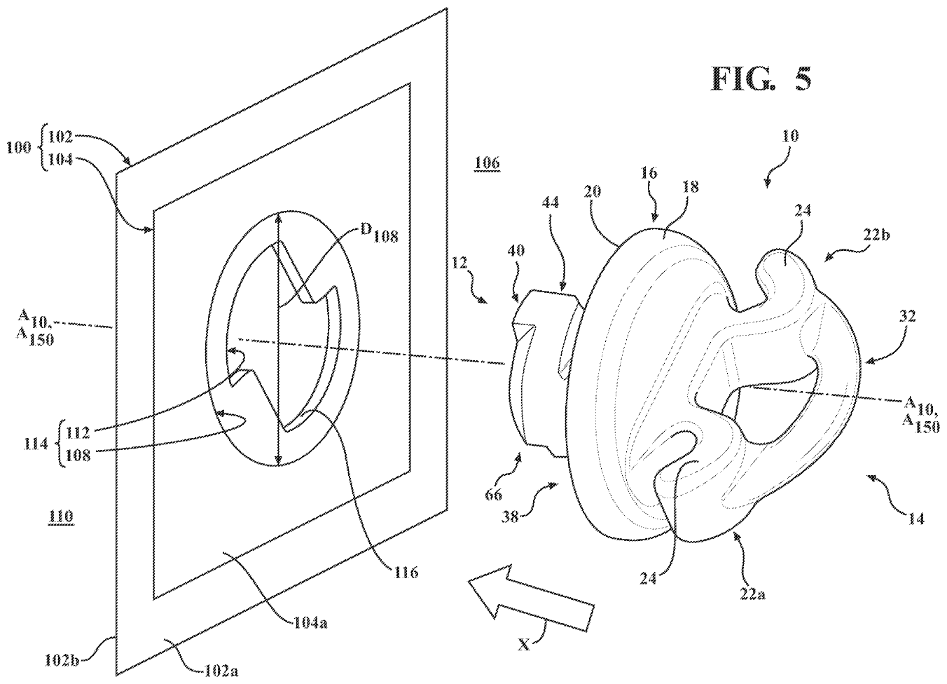

Referring to FIGS. 1A-1C, 2, 3, and 4, a cargo hook 10 that is configured for attachment to a portion of a frame of a vehicle 100 (see, e.g., FIGS. 5, 6A-6B, and 7A-7B) is shown in accordance with an implementation of the present disclosure. The cargo hook 10 may be formed including any desirable material (e.g., plastic) or combination of materials, and may be formed in any desirable process (e.g., injection molding).

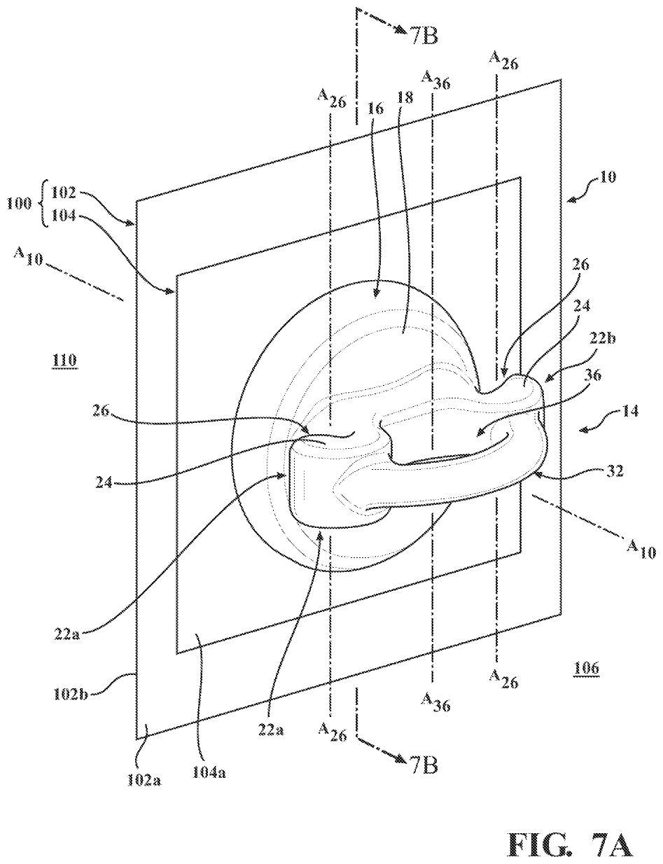

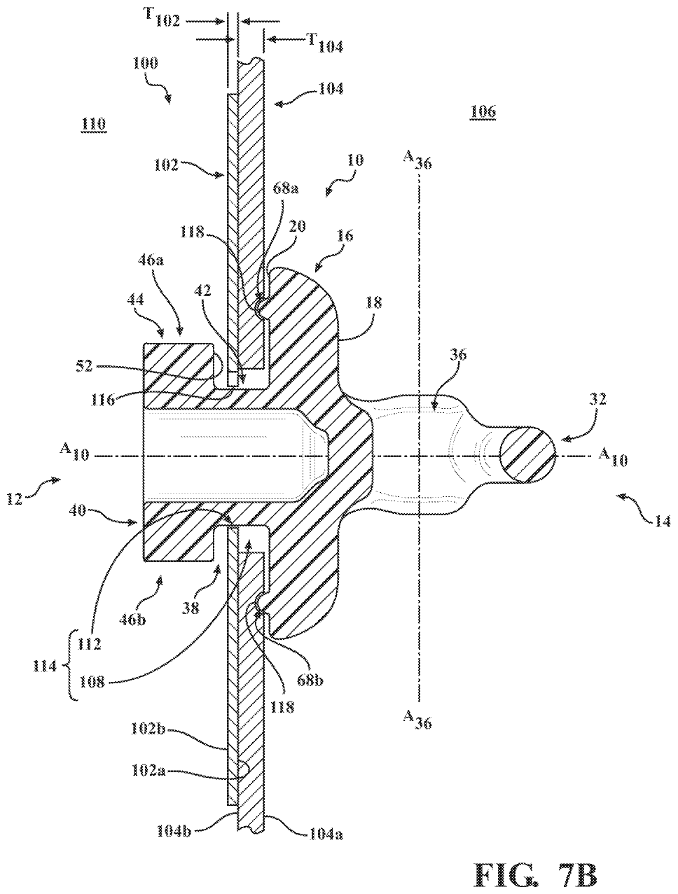

Referring initially to FIG. 1, the cargo hook 10 includes a proximal body portion 12 and a distal body portion 14. The proximal body portion 12 is configured to be received by a cavity 110 (see, e.g., FIG. 7B) of the frame of the vehicle 100. The proximal body portion 12 may be alternatively referred to as an anchor body portion. The distal body portion 14 is configured to be exposed to a passenger compartment area 106 (see, e.g., FIG. 7B) of the frame of the vehicle 100 when the proximal body portion 12 is received by the cavity 110. The distal body portion 14 may be alternatively referred to as a fixture portion.

In some implementations, the fixture portion 14 may be configured to retain a cargo net interface portion 200a, 200b (see, e.g., FIGS. 1B, 1C) of a cargo net (not shown). Referring to FIG. 1B, in some implementations, the cargo net interface portion 200a is an elastic cord (see, e.g., FIG. 1B). Referring to FIG. 1C, in other implementations, the cargo net interface portion 200b is a plastic hook, a karabiner hook, or the like. Accordingly, in some configurations, the fixture portion 14 may be alternatively referred to as a cargo net hook body portion.

Referring to FIGS. 1A-4, the cargo net hook body portion 14 extends from a hook body base 16 having a first side 18 and a second side 20. The second side 20 of the hook body base 16 is disposed opposite from the first side 18 of the hook body base 16. In the illustrated example, the first side 18 generally defines the hook body base 16 to have a dome shape and the second side 20 generally defines the hook body base 16 to have a flat, circular shape. Referring to FIG. 4, in some implementations, the flat, circular shape of the hook body base 16 defined by the second side 20 is further defined by a diameter D₁₆.

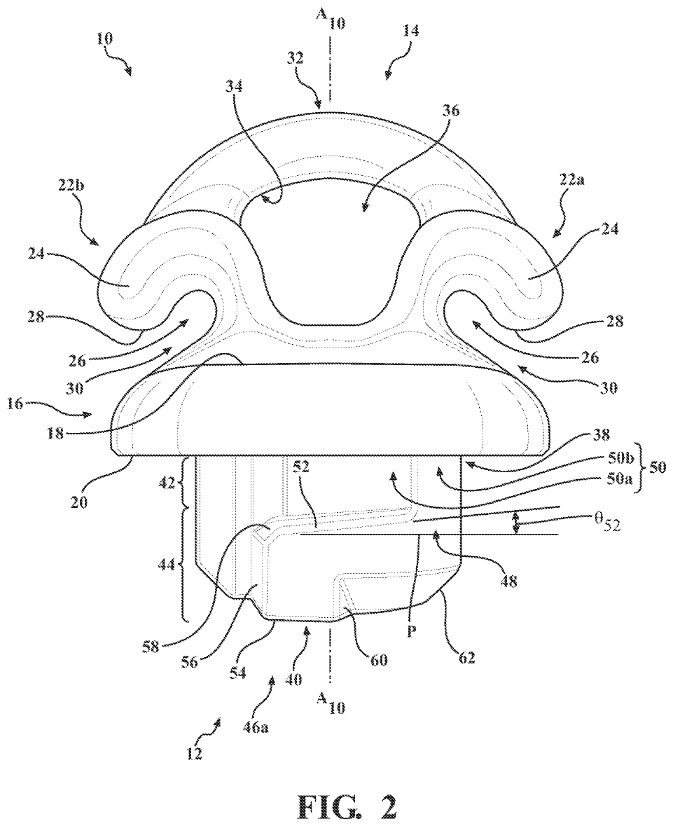

Referring to FIGS. 1A and 2, the cargo net hook body portion 14 includes one or more hook members 22a, 22b. As seen at FIG. 2, the one or more hook members 22a, 22b include a pair of hook members including a first hook member 22a and a second hook member 22b that are diametrically opposed across the cargo net hook body portion 14.

In some implementations, with reference to FIG. 2, each of the first hook member 22a and the second hook member 22b includes an arcuate body 24 defining a first hook opening 26 extending in an axial direction along an axis A₂₆-A₂₆ (see, e.g., FIG. 1) through a thickness of the first hook member 22a and the second hook member 22b. In other implementations, an inwardly-facing side 28 of the arcuate body 24 of each of the first hook member 22a and the second hook member 22b and the first side 18 of the hook body base 16 cooperate to define a second hook opening 30 that permits radial access to the first hook opening 26 extending along the axis A₂₆-A₂₆. Thus, as shown, the second hook opening 30 provides a peripheral opening into the first hook opening 26, formed between a terminal end of each of the hook members 22a, 22b and the first side 18 of the hook body base 16, whereby portions of the cargo net can be inserted in a radial direction into the first hook openings 26 through the second hook openings 30.

In further implementations, the cargo net hook body portion 14 includes a cross member 32. The cross member 32 extends across and connects the first hook member 22a and the second hook member 22b. Referring to FIGS. 1A and 2, the first side 18 of the hook body base 16, the first hook member 22a, the second hook member 22b, and the cross member 32 cooperate to define a loop member 34. The loop member 34 defines a third hook opening 36. The third hook opening 36 extends in an axial direction along an axis A₃₆-A₃₆ (see, e.g., FIG. 1) through the loop member 34.

Referring to FIG. 1B, one or both of the first hook opening 26 and the third hook opening 36 is/are configured to permit passage and selective retention of the elastic cord 200a of the cargo net for removably-securing the elastic cord 200a to the cargo net hook body portion 14. In some instances, the elastic cord 200a is configured to be arranged within the first hook openings 26 by radially inserting the elastic cord 200a into the first hook openings 26 by way of the second hook openings 30. In other implementations, the elastic cord 200a is configured to be arranged within the third hook opening 36 and radially supported upon and/or below the cross member 32.

Referring to FIG. 1C, the third hook opening 36 is configured to permit passage and selective retention of the plastic hook 200b of the cargo net for removably-securing the plastic hook 200b to the cargo net hook body portion 14. In some instances, the plastic hook 200b is permitted to be axially arranged within the third hook opening 36 by: arranging a nose portion 202b of the plastic hook 200b over the cross member 32; axially inserting the nose portion 202b of the plastic hook 200b into the third hook opening 36; and arranging the nose portion 202b of the plastic hook 200b under the cross member 32 whereby a head portion 204b of the plastic hook 200b is arranged within the third hook opening 36 and positioned between the cross member 32 and the first side 18 of the hook body base 16.

Referring to FIG. 2, aspects of the anchor body portion 12 are shown in accordance with an implementation of the present disclosure. The anchor body portion 12 includes proximal first end 38 and a distal second end 40. The proximal first end 38 of the anchor body portion 12 is attached to and extends from the second side 20 of the hook body base 16. A central rotational axis A₁₀-A₁₀ (see also, e.g., FIGS. 1A, 3, and 5-7B) of the cargo hook 10 extends through an axial center C (see, e.g., FIG. 4) of the anchor body portion 12.

With continued reference to FIG. 2, the anchor body portion 12 is defined by an anchor neck 42 and an anchor head 44. The anchor neck 42 extends from the proximal first end 38 of the anchor body portion 12 and is attached to the second side 20 of the hook body base 16. The anchor head 44 extends from a distal end of the anchor neck 42 and terminates at the distal second end 40 of the anchor body 12.

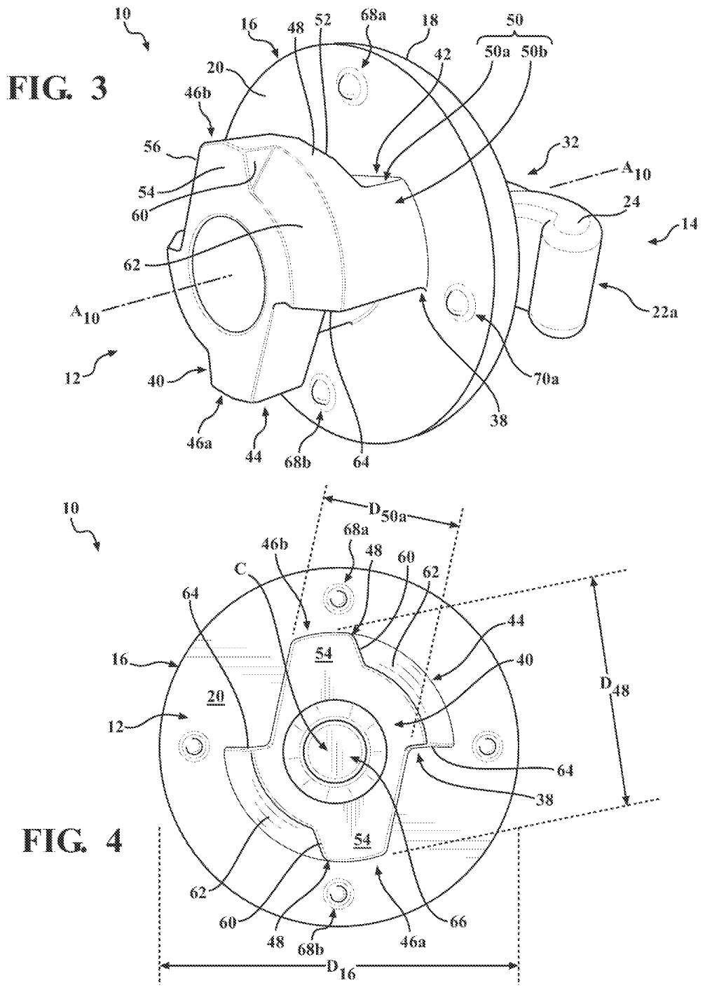

Referring to FIGS. 3 and 4, the anchor head 44 includes one or more anchor wings 46a, 46b. The one or more anchor wings 46a, 46b include a pair of anchor wings including a first anchor wing 46a and a second anchor wing 46b that are diametrically opposed across the anchor body portion 12.

Referring to FIG. 2, each of the first anchor wing 46a and the second anchor wing 46b includes an outermost wing side surface 48 that extends further radially outwardly (relative the axial center C of the anchor body portion 12) than at least a first neck side surface 50a of the anchor neck 42. Accordingly, a distance D₄₈ (see, e.g., FIG. 4) extending across the outermost wing side surfaces 48 the first anchor wing 46a and the second anchor wing 46b is greater than a distance D₅₀ₐ (see, e.g., FIG. 4) extending across the first neck side surfaces 50a of the anchor neck 42. In the illustrated example, the outermost wing side surface 48 each of the first anchor wing 46a and the second anchor wing 46b is arcuate, such the distance extending across the outermost wing side surface 48 of the first anchor wing 46a and the second anchor wing 46b may corresponds to a diameter.

With continued reference to FIG. 2, the anchor neck 42 includes second neck side surfaces 50b, which cooperate with the first neck side surfaces 50a to define a neck side surface 50. As seen at FIGS. 2 and 3, the second neck side surfaces 50b extend toward and converge with the outermost wing side surface 48 of each of the first anchor wing 46a and the second anchor wing 46b. Unlike the first neck side surfaces 50a of the anchor neck 42, the second neck side surfaces 50b of the anchor neck 42 are not arranged further radially inwardly of the outermost wing side surface 48 of each of the first anchor wing 46a and the second anchor wing 46b. In other words, the second neck side surfaces 50b may be flush with the outermost wing side surfaces 48.

Referring to FIG. 2, in some implementations, each of the first anchor wing 46a and the second anchor wing 46b includes a first end surface 52 and a second end surface 54. The first end surface 52 of each of the first anchor wing 46a and the second anchor wing 46b is disposed opposite the second end surface 54 of each of the first anchor wing 46a and the second anchor wing 46b. The first end surface 52 of each of the first anchor wing 46a and the second anchor wing 46b is disposed opposite (i.e., faces) the second side 20 of the hook body base 16.

The first neck side surfaces 50a of the anchor neck 42 extend from the first end surface 52 of each of the first anchor wing 46a and the second anchor wing 46b to the second side 20 of the hook body base 16. Furthermore, the first neck side surface 50a of the anchor neck 42 is spaced radially inwardly (relative the axial center C of the anchor body portion 12) from the outermost wing side surface 48 of each of the first anchor wing 46a and the second anchor wing 46b. In the illustrated example, the first neck side surfaces 50a are substantially flat or planar.

With continued reference to FIG. 2, in some examples, each of the first anchor wing 46a and the second anchor wing 46b include a lead surface 56. For each of each of the first anchor wing 46a and the second anchor wing 46b, the lead surface 56 extends from the first end surface 52 to the second end surface 54. In other examples, as also seen at FIG. 2, each of the first anchor wing 46a and the second anchor wing 46b includes a first chamfer surface 58. The first chamfer surface 58 extends between the lead surface 56 and the first end surface 52 of each of the first anchor wing 46a and the second anchor wing 46b.

Furthermore, in some configurations, the first end surface 52 converges with the second side 20 of the hook body base 16 along a direction from the lead surface 56, as shown in FIG. 2. For example, the first end surface 52 of each of the first anchor wing 46a and the second anchor wing 46b is oriented at an oblique angle θ₅₂ (as seen at, e.g. FIG. 2). The oblique angle θ₅₂ is referenced from a plane P (see, e.g., FIG. 2) extending across the anchor head 44 that is arranged below the first end surface 52 of each of the first anchor wing 46a and the second anchor wing 46b. The plane P is orthogonal to the central rotational axis A₁₀-A₁₀ of the cargo hook 10 and parallel to the second side 20 of the hook body base 16. Because the first end surfaces 52 of each of the first anchor wing 46a and the second anchor wing 46b are oriented at the oblique angle θ₅₂, the first end surfaces 52 of each of the first anchor wing 46a and the second anchor wing 46b may partially define the anchor head 44 to include a helix shape, a spiral shape, or the like that assists in the attachment of the cargo hook 10 to the frame of the vehicle 100, as will be described in the following disclosure.

With continued reference to FIG. 2, in other examples, each of the first anchor wing 46a and the second anchor wing 46b includes a first trailing surface 60. The first trailing surface 60 is formed on an opposite side from the lead surface 56 and extends from the second end surface 54 of each of the first anchor wing 46a and the second anchor wing 46b.

With further reference to FIG. 2, each of the first anchor wing 46a and the second anchor wing 46b includes chamfered surface 62. The chamfered surface 62 forms a chamfer between second end surface 54 and the outermost wing side surface 48 of each of the first anchor wing 46a and the second anchor wing 46b, and the first trailing surface 60 of each of the first anchor wing 46a and the second anchor wing 46b. As also seen at FIG. 2, each of the first anchor wing 46a and the second anchor wing 46b includes second trailing surface 64.

Referring now to FIG. 4, a plurality of surfaces of both of the first anchor wing 46a and the second anchor wing 46b cooperate to define a locking profile 66 of the anchor head 44 of the anchor body portion 12. The plurality of surfaces of both of the first anchor wing 46a and the second anchor wing 46b that cooperate to define the locking profile 66 of the anchor head 44 of the anchor body portion 12 include, for example: the second end surfaces 54; the lead surfaces 56; the outermost wing side surfaces 48; the first trailing surfaces 60; the chamfered surfaces 62; and the second trailing surfaces 64.

As seen at FIG. 4, the locking profile 66 is defined by the plurality of surfaces of both of the first anchor wing 46a and the second anchor wing 46b. However, the locking profile 66 may be alternatively defined, at least in part, by the convergence of two or more of any of the plurality of surfaces of both of the first anchor wing 46a and the second anchor wing 46b including, for example: the second end surface 54; the lead surface 56; the outermost wing side surface 48; the first trailing surface 60; the chamfered surface 62; and the second trailing surface 64. Accordingly, in some instances, the locking profile 66 may be generally defined by a substantially “Z shaped” pattern that is bound by the plurality of surfaces of both of the first anchor wing 46a and the second anchor wing 46b.

Referring now to FIG. 5, the frame of the vehicle 100 is shown in accordance with an implementation of the present disclosure. The frame of the vehicle 100 includes, for example, one or both of a sheet metal portion 102 and a garnish portion 104.

The garnish portion 104 is arranged over the sheet metal portion 102, and, as such, may be alternatively referred to as a trim panel that provides an aesthetically pleasing appearance to the passenger compartment area 106 (see, e.g., FIG. 7B) of the frame of the vehicle 100. Accordingly, the garnish portion 104 may define an “A Side” of the frame of the vehicle 100. The garnish portion 104 includes an access passage 108 that permits access to the sheet metal portion 102, which may be said to be positioned “behind” the garnish portion 104 (from the perspective of an occupant within the passenger compartment area 106 of the frame of the vehicle 100). In some implementations the access passage 108 is defined by a passage diameter D₁₀₈.

Because the sheet metal portion 102 may be to be positioned “behind” the garnish portion 104, and, supports other components of the frame of the vehicle 100, the sheet metal portion 102 may be alternatively referred to as a substrate panel of the frame of the vehicle 100. In some configurations, the sheet metal portion 102 may contribute to defining the cavity 110 (see, e.g., FIG. 7B) of the frame of the vehicle 100. Accordingly, because the sheet metal portion 102 may be alternatively referred to as a substrate panel that is not visible to the passenger in the passenger compartment area 106 of the frame of the vehicle 100, the sheet metal portion 102 may define a “B Side” of the frame of the vehicle 100.

With reference to FIG. 7B, the garnish portion 104 includes an A-surface-facing side 104a and a B-surface-facing side 104b. The garnish portion 104 is further defined by a thickness T₁₀₄ extending between the A-surface-facing side 104a and the B-surface-facing side 104b. The access passage 108 extends through the thickness T₁₀₄ of the garnish portion 104. The A-surface-facing side 104a of the garnish portion 104 contributes to defining the passenger compartment area 106 of the frame of the vehicle 100.

With continued reference to FIG. 7B, the sheet metal portion 102 includes an A-surface-facing side 102a and a B-surface-facing side 102b. The sheet metal portion 102 is further defined by a thickness T₁₀₂ (see, e.g., FIG. 7B) extending between the A-surface-facing side 102a and the B-surface-facing side 102b. A keyed passage 112 extends through the thickness T₁₀₂ of the sheet metal portion 102. The B-surface-facing side 102b of the sheet metal portion 102 contributes to defining the cavity 110 of the frame of the vehicle 100. The keyed passage 112 may be formed in any desirable process such as, for example, stamping, die-cutting, molding, or the like.

Collectively, the access passage 108 of the garnish portion 104 and the keyed passage 112 of the sheet metal portion 102 may define a frame passage 114 (see, e.g., FIG. 7B) of the frame of the vehicle 100. The frame passage 114 extends at a distance defined by the thickness T₁₀₄ of the garnish portion 104 and the thickness T₁₀₂ of the sheet metal portion 102.

Referring to FIGS. 5 and 7B, the keyed passage 112 is defined by the one or more passage surfaces 116 arranged in the thickness T₁₀₂ of the sheet metal portion 102. The one or more passage surfaces 116 connect the A-surface-facing side 102a of the sheet metal portion 102 to the B-surface-facing side 102b of the sheet metal portion 102.

With continued reference to FIG. 5 and FIG. 7B, when the garnish portion 104 is attached to the sheet metal portion 102, the B-surface-facing side 104b of the garnish portion 104 is disposed opposite or positioned adjacent the A-surface-facing side 102a of the sheet metal portion 102. After attachment of the garnish portion 104 to the sheet metal portion 102, the access passage 108 formed by the garnish portion 104 is configured to permit access to the keyed passage 112 formed by the sheet metal portion 102. As a result, a portion of the sheet metal portion 102 that defines the keyed passage 112 is exposed to the passenger compartment area 106 of the frame of the vehicle 100 by the access passage 108 formed by the garnish portion 104. The resulting exposure of the keyed passage 112 to the passenger compartment area 106 of the frame of the vehicle 100 by the access passage 108 formed by the garnish portion 104 permits subsequent attachment of the cargo hook 10 in a subsequent assembling step that will be described in the following disclosure.

The keyed passage 112 of the sheet metal portion 102 is configured to have a similar shape to the locking profile 66 of the anchor head 44 of the anchor body portion 12. As seen comparatively at FIGS. 4, 5, and 6B, like the locking profile 66 of the anchor head 44 of the anchor body portion 12 and the keyed passage 112 are generally both represented by the “Z shaped” (whereby the keyed passage 112 of the sheet metal portion 102 is bound by the one of more passage surfaces 116 of the sheet metal portion 102). More specifically, the one or more passage surfaces 116 of the sheet metal portion 102 generally correspond to the convergence of two or more of the surfaces of each of the first anchor wing 46a and the second anchor wing 46b that define the locking profile 66 being, at least in part, for example: the second end surface 54; the lead surface 56; the outermost wing side surface 48; the first trailing surface 60; the chamfered surface 62; and the second trailing surface 64. Accordingly, in some instances, like the locking profile 66, the keyed passage 112 may also be generally defined by a substantially “Z shaped” pattern that is bound by the one of more passage surfaces 116 of the sheet metal portion 102. As such, the “Z shape” of the anchor head 44 acts as a keyed male portion that is configured for insertion into the corresponding keyed female portion of the “Z shape” defined by the keyed passage 112 of the sheet metal portion 102.

Referring to FIGS. 5-7B, a method of assembling a subassembly 150 is shown in accordance with an implementation of the present disclosure. The subassembly 150 includes the cargo hook 10 and the frame of the vehicle 100.

As seen at FIG. 5, the cargo hook 10 is arranged within a passenger compartment area 106 of the frame of the vehicle 100 and is positioned opposite the keyed passage 112 of the sheet metal portion 102. Thereafter, the locking profile 66 of the anchor head 44 of the anchor body portion 12 of the cargo hook 10 is axially aligned along an axis A₁₅₀-A₁₅₀ of the subassembly 150, such that axis A₁₅₀-A₁₅₀ of the subassembly 150 is coaxial with the central rotational axis A₁₀-A₁₀ of the cargo hook 10. Thereafter, the locking profile 66 of the anchor head 44 of the anchor body portion 12 of the cargo hook 10 is rotationally aligned about the central rotational axis A₁₀-A₁₀ of the cargo hook 10 for aligning both of the first anchor wing 46a and the second anchor wing 46b that define the locking profile 66 with corresponding portions of the keyed passage 112 of the sheet metal portion 102.

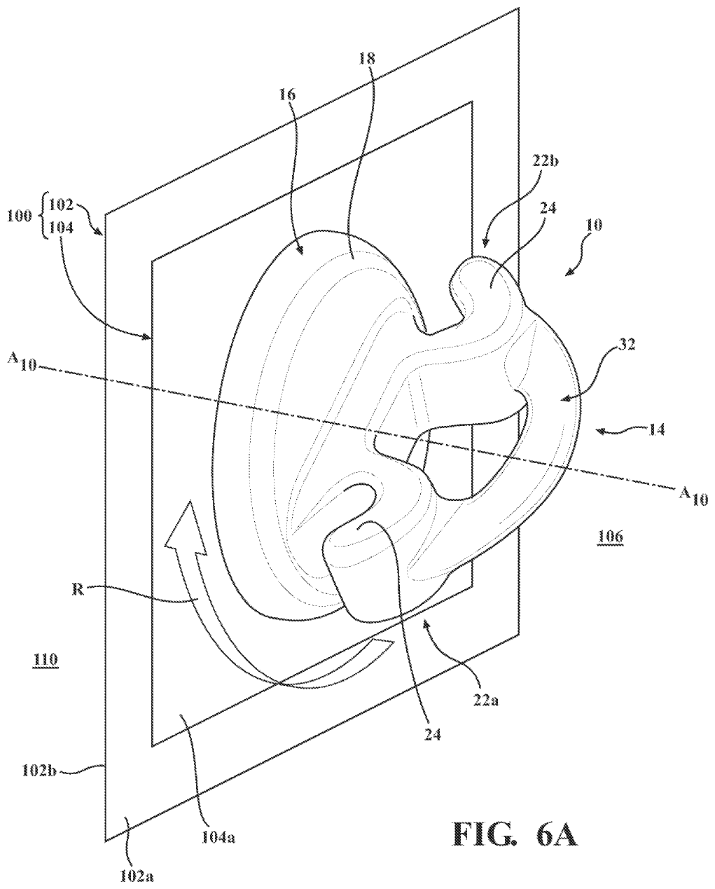

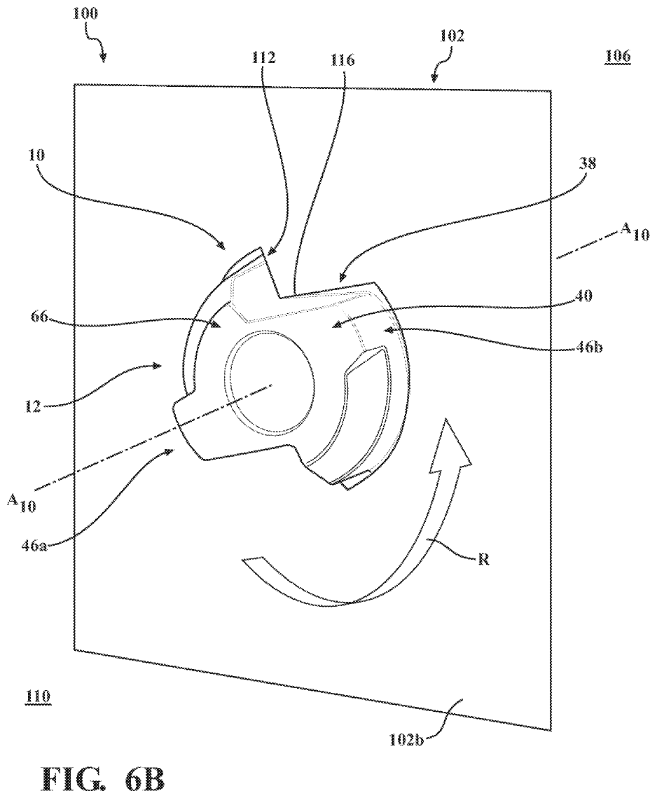

Referring to FIGS. 6A-6B, in a subsequent step, the anchor head 44 of the anchor body portion 12 of the cargo hook 10 is passed through the access passage 108 formed by the garnish portion 104 and then passed through the keyed passage 112 of the sheet metal portion 102 according to the direction of the arrow X (see, e.g., FIG. 5) In other words, the anchor head 44 of the anchor body portion 12 of the cargo hook 10 is passed through the frame passage 114 of the frame of the vehicle 100. If the locking profile 66 of the anchor head 44 of the anchor body portion 12 of the cargo hook 10 is not sufficiently rotated about the central rotational axis A₁₀-A₁₀ of the cargo hook 10 such that the both of the first anchor wing 46a and the second anchor wing 46b that define the locking profile 66 are not aligned with corresponding portions of the keyed passage 112 of the sheet metal portion 102, the anchor head 44 of the anchor body portion 12 of the cargo hook 10 is prohibited from being passed through the keyed passage 112 of the sheet metal portion 102.

As seen at FIG. 6A, the act of passing the anchor head 44 of the anchor body portion 12 of the cargo hook 10 through the frame passage 114 of the frame of the vehicle 100 ceases when the second side 20 of the hook body base 16 of the cargo net hook body portion 14 of the cargo hook 10 comes into contact with and is disposed opposite or adjacent the A-surface-facing side 104a of the garnish portion 104. Furthermore, the diameter D₁₆ (see, e.g., FIG. 4) of the hook body base 16 is configured to be greater than the passage diameter D₁₀₈ (see, e.g., FIG. 5) of the access passage 108 formed by the garnish portion 104 in order to close-out the access passage 108 formed by the garnish portion 104 and obscure from sight the portion of the sheet metal portion 102 that would otherwise be exposed to the passenger compartment area 106 of the frame of the vehicle 100.

Referring to FIG. 7B, after passing the anchor head 44 of the anchor body portion 12 of the cargo hook 10 through the frame passage 114 of the frame of the vehicle 100 as described above, the anchor neck 42 of the anchor body portion 12 is substantially arranged within the frame passage 114 of the frame of the vehicle 100. Additionally, as seen at FIGS. 6B and 7B, after passing the anchor head 44 of the anchor body portion 12 of the cargo hook 10 through the frame passage 114 of the frame of the vehicle 100 as described above, the anchor head 44 of the anchor body portion 12 of the cargo hook 10 is arranged axially beyond the B-surface-facing side 102b of the sheet metal portion 102 such that the anchor head 44 of the anchor body portion 12 of the cargo hook 10 is arranged within the cavity 110 of the frame of the vehicle 100.

With reference to FIGS. 6A and 6B, after the anchor head 44 of the anchor body portion 12 of the cargo hook 10 is arranged axially beyond the B-surface-facing side 102b of the sheet metal portion 102 such that the anchor head 44 of the anchor body portion 12 of the cargo hook 10 is arranged within the cavity 110 of the frame of the vehicle 100, the cargo hook 10 is then rotated R about the central rotational axis A₁₀-A₁₀ of the cargo hook 10 relative the frame of the vehicle 100. The rotation R of the cargo hook 10 relative the frame of the vehicle 100 results in the locking profile 66 not being aligned with corresponding portions of the keyed passage 112 of the sheet metal portion 102 whereby removal of the cargo hook 10 away from the frame of the vehicle 100 in a direction opposite the arrow X is prohibited.

Furthermore, as seen at FIG. 7B, after the anchor head 44 of the anchor body portion 12 of the cargo hook 10 is arranged axially beyond the B-surface-facing side 102b of the sheet metal portion 102 such that the anchor head 44 of the anchor body portion 12 of the cargo hook 10 and subsequently rotated R, the first end surface 52 of each of the first anchor wing 46a and the second anchor wing 46b of the anchor head 44 of the anchor body portion 12 of the cargo hook 10 is arranged opposite the B-surface-facing side 102b of the sheet metal portion 102. Because the first end surface 52 of each of the first anchor wing 46a and the second anchor wing 46b of the anchor head 44 of the anchor body portion 12 of the cargo hook 10 is oriented at the oblique angle θ₅₂ and is arranged opposite the B-surface-facing side 102b of the sheet metal portion 102, the rotation R of the cargo hook 10 about the central rotational axis A₁₀-A₁₀ of the cargo hook 10 results in both of the first anchor wing 46a and the second anchor wing 46b of the anchor head 44 of the anchor body portion 12 of the cargo hook 10 being drawn closer to the B-surface-facing side 102b of the sheet metal portion 102 in a progressive manner such that the cargo hook is drawn to the sheet metal portion 102 in a progressively tighter relationship as the cargo hook 10 is rotated. The progressive tightening of the cargo hook 10 adjacent the frame of the vehicle 100 mitigates loosening of the cargo hook 10 from the frame of the vehicle 100 during use of the vehicle while also mitigating noise (e.g., rattling) should the first end surface 52 of both of the first anchor wing 46a and the second anchor wing 46b of the anchor head 44 of the anchor body portion 12 of the cargo hook 10 not be sufficiently disposed adjacent the B-surface-facing side 102b of the sheet metal portion 102 frame of the vehicle 100.

Referring to FIGS. 6A-6B, rotation R of the cargo hook 10 at a first rotation angle (according to the direction of the arrow R) relative the frame of the vehicle 100 results in a horizontal alignment (as seen at, e.g., FIG. 7A) of the first hook member 22a, the second hook member 22b, and the cross member 32 of the cargo net hook body portion 14 within the passenger compartment area 106 of the frame of the vehicle 100. In some implementations, the first rotation angle of the cargo hook 10 relative the frame of the vehicle 100 may be approximately 65°. If desired, the cargo hook 10 may be further rotated (according to the direction of the arrow R) relative the frame of the vehicle 100 at a second rotation angle in order to result in the vertical alignment (not shown) of the first hook member 22a, the second hook member 22b, and the cross member 32 of the cargo net hook body portion 14 within the passenger compartment area 106 of the frame of the vehicle 100. In some implementations, the second rotation angle of the cargo hook 10 relative the frame of the vehicle 100 may be approximately 155°.

Referring back to FIG. 3, in other implementations, the second side 20 of the hook body base 16 of the cargo net hook body portion 14 of the cargo hook 10 may include a plurality of protrusions 68a, 68b, 70a. The plurality of protrusions 68a, 68b, 70a include a first pair of opposing protrusions defined by a first protrusion 68a arrange opposite a second protrusion 68b. The plurality of protrusions 68a, 68b, 70a include a second pair of opposing protrusions defined by a third protrusion 70a arranged opposite a fourth protrusion (not shown). When the cargo hook 10 is rotated relative the frame of the vehicle 100 as described above, the plurality of protrusions 68a, 68b, 70a may register within corresponding depressions 118 (see, e.g., FIG. 7B) formed in the A-surface-facing side 102a, 104a of the sheet metal portion 102 or the garnish portion 104. Upon arrangement of the plurality of protrusions 68a, 68b, 70a within the corresponding depressions 118 formed in the A-surface-facing side 102a, 104a of the sheet metal portion 102 or the garnish portion 104, a user that is rotating the cargo hook 10 may receive tactile feedback of the plurality of protrusions 68a, 68b, 70a snapping or flexing into the corresponding depressions 118 formed in the A-surface-facing side 102a, 104a of the sheet metal portion 102 or the garnish portion 104. Furthermore, upon registering the plurality of protrusions 68a, 68b, 70a into the corresponding depressions 118 formed in the A-surface-facing side 102a, 104a of the sheet metal portion 102 or the garnish portion 104, the resulting registration provides an anti-rotation function that prevents the cargo hook 10 from undesirably rotating relative the frame of the vehicle 100 in a direction opposite the direction of the arrow R.

As a result of the design of the cargo hook 10 and the frame of the vehicle 100, which gives rise to the subassembly 150 described above, an efficient attachment of the cargo hook 10 to the frame of the vehicle 100 is provided. The attachment arises from a simple insertion X (see, e.g., FIG. 5) of the cargo hook 10 into the frame passage 114 of the frame of the vehicle 100 and a subsequent rotation R (see, e.g., FIGS. 6A-6B) of the cargo hook 10 relative the frame of the vehicle 100. Accordingly, the subassembly 150 is provided without the use of fasteners or equipment.

A number of implementations have been described. Nevertheless, it will be understood that various modifications may be made without departing from the spirit and scope of the disclosure. Accordingly, other implementations are within the scope of the following claims.

The foregoing description has been provided for purposes of illustration and description. It is not intended to be exhaustive or to limit the disclosure. Individual elements or features of a particular configuration are generally not limited to that particular configuration, but, where applicable, are interchangeable and can be used in a selected configuration, even if not specifically shown or described. The same may also be varied in many ways. Such variations are not to be regarded as a departure from the disclosure, and all such modifications are intended to be included within the scope of the disclosure.

What is claimed is:

1. A cargo hook for a motor vehicle comprising:
a hook body base having a first side and a second side disposed on an opposite side from the first side, and a cargo net hook body portion attached to the first side of the hook body base; and
an anchor body portion including (i) an anchor neck extending from a proximal first end attached to the second side of the hook body base to a distal second end and defining a central rotational axis and (ii) an anchor head disposed at the distal second end of the anchor neck and including one or more anchor wings extending radially outwardly to an outermost wing side surface from the anchor neck.

2. The cargo hook of claim 1, wherein each of the one or more anchor wings includes a first end surface disposed opposite the second side of the hook body base and a second end surface disposed on an opposite side from the first end surface.

3. The cargo hook of claim 2, wherein each of the one or more anchor wings include a lead surface extending from the first end surface to the second end surface.

4. The cargo hook of claim 3, wherein each of the one or more anchor wings include a first chamfer surface extending between the first end surface and the lead surface.

5. The cargo hook of claim 4, wherein the first end surface is oriented at an oblique angle (θ₅₂) relative to the central rotational axis of the anchor body portion.

6. The cargo hook of claim 5, wherein the first end surface converges with the second side of the hook body base along a direction from the lead surface.

7. The cargo hook of claim 6, wherein the anchor neck defines a first portion of a neck side surface extending from the first end surface to the second side of the hook body base and spaced radially inwardly from the outermost wing side surface.

8. The cargo hook of claim 1, wherein the cargo net hook body portion includes one or more hook members.

9. The cargo hook of claim 8, wherein the one or more hook members includes a diametrically opposed pair of hook members including a first hook member and a second hook member.

10. The cargo hook of claim 9, wherein each of the first hook member and the second hook member includes an arcuate body defining (i) a first hook opening extending in an axial direction through each of the first hook member and the second hook member and (ii) a second hook opening that permits radial access to the first hook opening.

11. The cargo hook of claim 9, wherein the cargo net hook body portion includes a cross member extending across and connecting the first hook member to the second hook member.

12. The cargo hook of claim 11, wherein the cross member, the first hook member, the second hook member, and the hook body base cooperate to define a loop member defining a third hook opening.

13. A cargo hook for a motor vehicle comprising:
a hook body base having a first side and a second side disposed on an opposite side from the first side,
a cargo net hook body portion attached to the first side of the hook body base, the cargo net hook body portion including a diametrically opposed pair of hook members and a cross member extending across and connecting the pair of the hook members; and
an anchor body portion configured to selectively attach the cargo hook to a frame of the motor vehicle.

14. The cargo hook of claim 13, wherein each hook member of the pair of the hook members includes an arcuate body defining a first hook opening extending in an axial direction through the hook member and a second hook opening that permits radial access to the first hook opening.

15. The cargo hook of claim 14, wherein the second hook opening of a first one of the pair of the hook members faces in an opposite direction from the second hook opening of a second one of the pair of the hook members.

16. The cargo hook of claim 13, wherein the cross member, the pair of the hook members, and the hook body base cooperate to define a loop member defining a third hook opening.

17. The cargo hook of claim 16, wherein the first hook opening of each of the pair of the hook members and the third hook opening extend in the same direction through the cargo net hook body portion.

18. The cargo hook of claim 13, wherein the cross member extends along an arcuate path across the pair of the hook members.

19. A cargo hook for a motor vehicle comprising:
a hook body base having a first side and a second side disposed on an opposite side from the first side,
a cargo net hook body portion attached to the first side of the hook body base, the cargo net hook body portion including a diametrically opposed pair of hook members and a cross member extending across and connecting the pair of the hook members; and
an anchor body portion including (i) an anchor neck extending from a proximal first end attached to the second side of the hook body base to a distal second end and defining a central rotational axis and (ii) an anchor head disposed at the distal second end of the anchor neck and including one or more anchor wings extending radially outwardly to an outermost wing side surface from the anchor neck.

20. The cargo hook of claim 19, wherein each hook member of the pair of the hook members includes an arcuate body defining a first hook opening extending in an axial direction through the hook member and a second hook opening that permits radial access to the first hook opening.
